(19) United States
(12) Patent Application Publication
(10) Pub. No.: US 2007/0271604 A1
(43) Pub. Date: Nov. 22, 2007

(54) Secure Transaction of Dna Data

(75) Inventors: Mitch Webster, Auckland (NZ); Oliver Horlacher, Auckland (NZ)

Correspondence Address: SPECKMAN LAW GROUP PLLC, 1201 THIRD AVENUE, SUITE 330, SEATTLE, WA, 98101, US

(73) Assignee: FIDELITYGENETIC LTD., Auckland (NZ)

(21) Appl. No.: 10/599,052

(22) PCT Filed: Mar. 17, 2005
(86) PCT No.: PCT/NZ05/00049

§ 371 Date: Jul. 6, 2007

(30) Foreign Application Priority Data
Mar. 17, 2004 (NZ) 531823

(51) Int. Cl. G06F 7/04

(52) U.S. Cl. 726/10

(57) ABSTRACT

A system and method for processing and storing personal information in a secure manner is described. In particular, a system and method for processing, splitting and storing genomic information or portions thereof in a secure electronic format is disclosed. An individual's genomic sequence is digitized and a splitting algorithm applied to fragment and randomise the digitized genomic information into at least two separate datasets. One dataset is retained by the individual and the second dataset is stored on a central server as a secure database record. Each dataset in isolation presents uninformative data and it is only when both datasets are combined, using a reconstruction algorithm to recombine the separate dataset data for an individual that the digitized data is capable of being presented into a useable and informative format.

### TECHNICAL FIELD

This invention relates to a system and method for processing and storing in a secure manner, personal information, and in particular, but not solely, to a method for securely processing, storing and retrieving genomic information in an electronic form for one or more individuals.

### PRIOR ART

The genome of an organism is believed to contain all the information required for the growth, development and maintenance of that organism. The sequencing of the human genome has signaled a new era in medicine, one in which genetic contributions to human health can be more readily considered. The publication of the draft human genome sequence (Eric S. Lander, et al. “Initial Sequencing and Analysis of the Human Genome.” Nature 409, 860-921 (Feb. 15, 2001) included an estimate that the human genome comprised only about 30,000 to 40,000 protein-encoding genes—much lower than previous estimates of around 100,000. A large number of these genes are involved in an individual's predisposition to disease. Furthermore, it is believed all diseases have a genetic component, whether the disease is inherited or results from the body's response to an environmental stress, such as, for example, exposure to viruses or toxins. An analysis of an individual's or population's genomic information will allow a determination of the genetic component or components that contribute to or cause disease.

As polynucleotide sequencing methods become amenable to the rapid determination of the genomic information of an individual or population, this genomic information will become available to individuals or populations, for example, as part of their medical profile. Decisions relating to the health of an individual or population can thereby be informed by an analysis of their genomic information.

For example, the genomic information of an individual or a population has application in diagnostic, therapeutic and preventative methods, such as, for example, gene testing, pharmacogenomics, gene therapy, genetic counseling, and genetic disease information

The prospect of a genomic medicine in which decisions relating to the health of an individual or population are informed by their genomic information, such as, for example, the determination of an individual's predisposition to disease, has the potential for significant benefit and significant detriment. For example, application of an individual's genomic information within the emerging field of pharmacogenomics may allow the identification of a subset of those drugs used to treat a particular disease or condition that are more likely to have therapeutic or preventative benefit to that individual. In another example, the determination of an individuals predisposition to disease based on their genomic information has the potential for discrimination in, for example, health insurance coverage or employment. The genomic information of an individual could be used to exclude high risk individuals from health insurance coverage by either denying or limiting coverage or by charging prohibitive rates. Conversely, low risk individuals may benefit from reduced health insurance costs.

WO97/31327 of Motorola Inc. discloses a personal human genome card with integrated machine-readable storage medium used to store a representation of nucleotide bases for at least a portion of the genome for an individual. The card may also store personal medical history information and genetic pedigree information. The personal genome card is carried by the individual for use in both medical and personal identification purposes. Integrated within the card is an interface used to communicate personal genome information between the card and a computer. In a further embodiment, a processor may also be integrated within the card and is used to limit external access to predetermined information stored on the card. Access is allowed or denied based on whether a predetermined access code, known only to the individual, is provided to the processor via the interface. The level of data security is limited in that all the data for the individual is stored in one place on a single card which may be accessed by emergency services thereby increasing the possibility of unauthorised access to the information contained therein and thereby, for example, personal discrimination.

In U.S. Pat. No. 6,513,720 issued to Jay A. Armstrong a personal electronic storage device or card is disclosed which is used to store personal and medical data and having the most private files protected using encryption techniques. The electronic storage device includes a built-in computer operating system compatible memory chip which can be plugged directly into a suitable computer interface device. Although the device can hold a physical genetic sample such as a strand of human hair, it is not used to store individual genomic information The device is a portable medical history file providing limited security features using complex encryption methods to protect only the sensitive aspects of the data.

The potential for great benefit and great detriment demands that access to an individual's genomic information be controlled. This is particularly important in situations where part or all of an individual's genomic information is stored, for example, electronically in a database. For example, the non-secure storage of an individual's genomic information at a central database may allow the disclosure of the genomic information without the consent of the individual. It is towards systems and methods that address issues relating to the privacy of genomic information and/or which ensure the safe and appropriate use of genomic information that the present invention is directed.

It is further towards the method of obtaining, organising and storing all or part of an individual's or population's genomic information that enable the secure storage of said genomic information in an electronic format that the present invention is directed.

It is therefore an object of the present invention to provide systems and methods for obtaining, processing, splitting and the storing of genomic information in a secure electronic format which go some way to overcoming the abovementioned disadvantages or at least provides the public with a useful choice.

### DISCLOSURE OF INVENTION

Accordingly, in a first aspect the present invention consists in a method for the secure storage of personal genomic information using a secure central database server comprising the steps of:

receiving and registering an individual's request to access and use said secure storage of personal genomic information system in a registration database and generating an interim unique identification code for said individual,

receiving and sequencing said individual's genomic sample to provide genomic information for said individual,

digitizing said genomic information,

applying a splitting algorithm to fragment and randomise said digitized genomic information and separating said fragmented and randomised information into at least two separate datasets,

storing at least one of said datasets in a portable storage device to be retained by said individual and storing the remainder of said datasets in a secure central database record,

activating said portable storage device by downloading an activation code from said secure central database server whereby said individual uses said interim unique identification code for authentication of their identity,

allocating to said individual a unique customer identifying code for customer identification and authentication purposes where said unique customer identifying code is also allocated to said secure central database record relating to said individual and said unique customer identification code is also allocated to said individual's personal record residing in said registration database,

receiving a request from said individual to reconstruct said individual's genomic information wherein said request includes said individual's customer identification code and log-on details,

authenticating said individual's request using said customer identification code and said log-on details and comparing the input data with said registration database,

downloading said individual's personal dataset from said individual's portable storage device using a machine-readable computer interface device, to said sequencing service outlet server,

uploading a secure central database record, identified by said individual's customer identification code and being identical to said customer identification code entered by said individual during user authentication, from said secure central database under the control of said sequencing service outlet, and

applying a reconstruction algorithm, residing within said sequencing service outlet database server to combine the data from said portable storage device with the data from said secure central database record and to provide said individual's genomic information in an informative format.

In a second aspect the invention consists in a method for the secure storage of personal genomic information with a sequencing service outlet comprising the steps of:

registering in a registration database an individual's request for use of said secure storage of personal genomic information,

generating two copies of a unique sample identification code in label form for tracking said individual's genomic sample and providing a interim method by which said individual can authenticate their identity,

receiving said individual's genomic information having one of said unique identification labels attached,

formatting said individual's genomic information such that said genomic information is amenable to the application of a splitting algorithm,

applying a splitting algorithm to fragment and randomise said digitized genomic information and separating said fragmented and randomised information into at least two separate datasets such that, in the absence of any one dataset, the remainder of the datasets present uninformative information,

storing at least one of said datasets in a portable storage device and storing the remainder of said datasets in a secure central database record,

providing said portable storage device to said individual,

receiving a log-on request from said individual,

authenticating said individual using the log-on details and said interim method of authenticating said individual's identity by comparing the input data with said registration database, and approving log-on when authentication is successful,

receiving a request for portable storage device activation when said individual uses said sample identification code for re-authentication of their identity,

activating said portable storage device by downloading an activation code to said portable storage device,

allocating to said individual a unique customer identifying code for customer identification and authentication purposes where said unique customer identifying code is also allocated to said secure central database record relating to said individual and said unique customer identification code is also allocated to said individual's personal record residing in said registration database,

receiving a request from said individual to reconstruct said individual's genomic information wherein said request includes said individual's customer identification code and log-on details,

authenticating said individual's request using said customer identification code and said log-on details and comparing the input data with said registration database,

downloading said individual's personal dataset from said individual's portable storage device using a machine-readable computer interface device, to said sequencing service outlet server,

uploading a secure central database record, identified by said individual's customer identification code and being identical to said customer identification code entered by said individual during user authentication, from said secure central database under the control of said sequencing service outlet, and

applying a reconstruction algorithm, residing within said sequencing service outlet database server to combine the data from said portable storage device with the data from said secure central database record and to provide said individual's genomic information in an informative format.

In a third aspect the invention consists in a method for the secure storage of personal genomic information whilst enabling non-anonymous transactions with a sequencing service outlet for third party access to all or fragments of an individual's genomic information comprising the steps of:

receiving a third party request for access to personal genomic information or fragments thereof,

logging said request in a third party registration database residing within the sequencing service outlet server,

generating a unique third party customer identification code thereby providing a method by which said third party can authenticate their identity,

receiving a log-on request from said individual,

authenticating said individual using the log-on details and a customer identification code input by said individual and comparing the input data with the registration database data, and approving log-on when authentication is successful,

receiving a third party transaction request from said individual,

recording said third party transaction request in a third party request database,

generating a unique third party transaction code for said request,

providing said third party transaction code to said individual,

receiving a third party data request from said third party which includes third party contact information, details at least the genes or genomic sequence interval and/or genomic information or portions thereof of said individual's genomic information required, to said sequencing service outlet server using said third party transaction code and said third party customer identification code for authentication of said third party,

authenticating said third party identity comparing said third party customer identification code and said third party contact information provided in said third party data request with details residing in said third party registration database, and approving third part access on successful completion of authentication,

posting of said third party data request to a data repository residing within said sequencing service outlet server for access and approval by said individual,

receiving authorisation for said third party request from said individual,

downloading said individual's personal dataset information from said individual's portable storage device using a machine-readable computer interface device, to said sequencing service outlet server,

uploading a secure central database record identified by said individual's customer identification code and being identical to said customer identification code entered by said individual during third party data request authorisation, from said secure central database under the control of said sequencing service outlet,

applying a reconstruction algorithm, residing within the sequencing service outlet database server to combining the data from said portable storage device with the data from said secure central database record to reproduce said individual's genomic information in an informative format,

isolating said genes or genomic sequence interval and/or genomic information or portions thereof of said genomic information according to said third party data request,

applying a splitting algorithm to fragment and randomise said digitized genomic information and separating said fragmented and randomised information into at least two separate datasets such that, in the absence of any one dataset, the remainder of the datasets presents uninformative information,

generating a data identification code as an access label for said datasets,

storing at least one of said datasets in a third party portable storage device and storing the remainder of said datasets in a secure public dataset database record under the control of said sequencing service outlet,

providing said third party portable storage device to said third party,

activating said third party portable storage device where said third party uses said data identification code and said third party customer identification code for authentication of their identity and an activation code is downloaded to said third party portable storage device,

receiving a request from said third party to reconstruct said individual's genomic information or portions thereof where said request includes said third party customer identification code and log-on details,

authenticating said third party request using said third party identification code, third party transaction code and said log-on details and comparing the input data with said third party registration database,

downloading said individual's personal dataset from said third party portable storage device using a machine-readable computer interface device, to said sequencing service outlet server,

uploading a secure public dataset record, identified by said third party transaction code and being identical to said third party transaction identification code entered by said third party during third party authentication, from said secure public database under the control of said sequencing service outlet, and

applying a reconstruction algorithm, residing within said sequencing service outlet database server to combine the data from said third party portable storage device with the data from said secure public database record and to provide said individual's genomic information in an informative format.

In a fourth aspect the invention consists in a method for the secure storage of personal genomic information whilst enabling anonymous transactions with a sequencing service outlet for third party access to whole genome sequences or fragments of an individual's genomic information comprising the steps of:

receiving, authenticating and approving if successful, a log-on request from said individual using said individual's computer log-on details and a customer identification comparing the data input with a registration database residing on a server in said sequencing service outlet,

receiving an information disclosure form request from said individual detailing at least details of the genes or genomic sequence interval and/or genomic information or portions thereof to be made available for access by an authorised third party,

downloading personal dataset information from said individual's portable storage device using a machine-readable computer interface device, to said sequencing service outlet server,

uploading of a secure central database record identified by said individual's customer identification code, from a secure central database under the control of said sequencing service outlet,

applying a reconstruction algorithm, residing within said sequencing service outlet server to combine the data from said portable storage device with the data from said secure central database record to reproduce said individual's genomic information in an informative format,

isolating and downloading said genes or genomic sequence interval and/or genomic information or portions thereof from said genomic information according to said information disclosure form request to a third party public access database record residing on a third party public access server under the control of said sequencing service outlet in a format such that said third party public access database record is anonymous having no link to a real world identity,

receiving, authenticating and approving if successful, a log-on request from a third party to provide using a third party identification code input by said third party and comparing the input data with a third party registration database record under the control of said sequencing service outlet,

receiving a third party data request detailing at least the details of the genes or genomic sequence interval and/or genomic information or portions thereof required, to said sequencing service outlet server,

uploading a third party public access database record corresponding to said third party data request, and

providing said third party public access database record to said third party.

### BRIEF DESCRIPTION OF THE DRAWINGS

FIG. 1 illustrates the steps undertaken in obtaining, coding, splitting and recombining the genomic information for an individual,

FIG. 2 illustrates a typical representation of an individual's genomic sequence,

FIG. 3 illustrates the steps for undertaking a non-anonymous third party transaction using the intrinsically safe DNA storage mechanisms in accordance with the present invention, and

FIG. 4 illustrates the steps for undertaking an anonymous third party transaction using the intrinsically safe DNA storage mechanisms of the present invention.

### BEST MODES FOR CARRYING OUT THE INVENTION

The present invention provides a system and method for the management and security of genomic information having a portion of the information stored in a personal portable form and another at least one portion of the information stored in a central database. More particularly the method as disclosed provides means for the sequencing, digitizing, splitting and storage of genomic information into at least two separate datasets for storage in a format such that data integrity and security is achieved whilst giving an individual a degree of control over their own genomic data.

Genomic information includes a representation of a sequence of nucleotide bases for at least a portion of the genome of an individual and/or the genomes of individual's comprising a population, such as for example, a family. The sequence of nucleotide bases can be determined from either a DNA sample or an RNA sample of the individual(s). The DNA or RNA sample(s) can be sequenced by methods well known in the art to determine either a partial nucleotide sequence or an entire nucleotide sequence of the genome of an individual(s). Rapid sequencing methods well known in the art are particularly amendable to use in the systems and methods of the invention.

Genomic information further includes annotation information comprising information about a nucleotide sequence, and may include any information relating to the physical and biological context of a nucleotide sequence.

The present invention provides a personal storage device such as a CD-Rom, optical disk or solid state device known as a Portable Storage Device and a remote central database, residing on a secure central database server which is referred to a Bank Data Set server, each containing an encoded stored representation of an individual's genomic information. The encoded genomic data includes at least a portion of the information being decode data, required to activate a recombining algorithm residing within the remote central database server, to decode and recombine the representation when the data held in the personal storage device and the remote central database to reproduce the individual's original genomic sequence.

The personal storage device is carried by the individual and may be used for medical and personal identification applications. The dataset stored on the device, in isolation, is meaningless and must be combined with the dataset stored in the central database (bank data set), corresponding to the same individual, in order to regenerate the individual's genomic information.

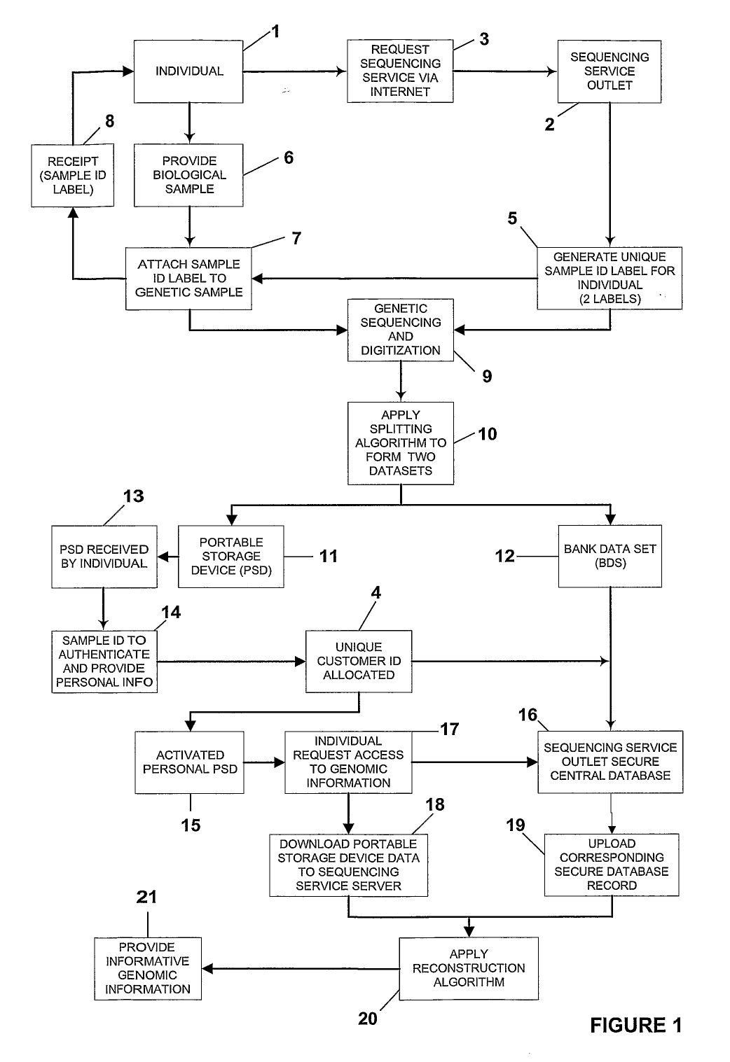

With reference to FIG. 1 an individual 1 may request to have their DNA sequenced to find out about their predisposition to known diseases or for pro-active health management purposes for example, as well as achieving a degree of control and security of their own genomic information. The individual 1 may apply to join the sequencing service outlet service by a number of different means including; over-the-counter at a sequencing service outlet 2, using a specific web page over the Internet 3, via a health service provider or alternatively via a pathology laboratory service provider. On payment of the appropriate fee a unique Customer identification code (Customer ID) 4 is generated for the individual although no detailed personal data is recorded within the customer database, although the customer may provide a return mailing address or other limited identifying means, until the customer has control over their personal dataset. A unique Sample Identification code (Sample ID) 5 is also generated by the sequencing service outlet of which two copies are created and forwarded to the pathology service provider, for example. The Sample ID 5 is typically a bar-coded label of the type known in the art.

A pathology service provider undertakes the sampling and preparation of the individual's biological sample 6 into an isolated and purified form, by any of the well known methods in the art, such that DNA and/or RNA sequencing can be undertaken by a sequencing service outlet 2. The pathology service provider attaches one of the Sample ID labels 7 to the individual's biological sample and the second label is retained by the individual 8 as a receipt and for customer authentication purposes on receipt of their personal dataset on a portable storage device 11.

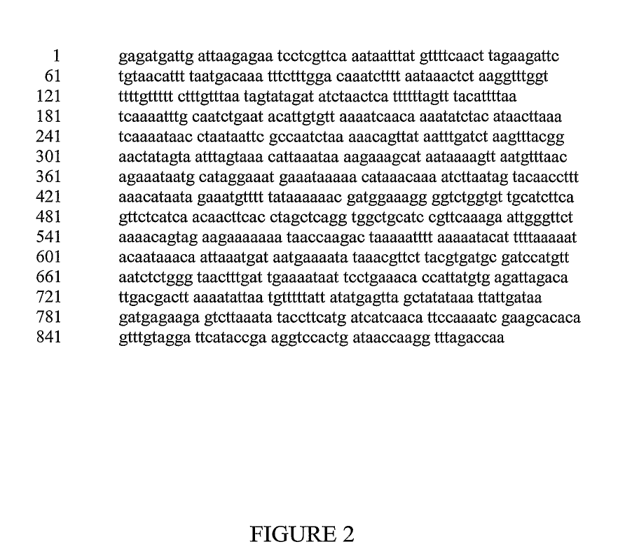

The sequencing service outlet 2 undertakes the DNA sequencing process 9 for the individual's purified sample using any of the methods currently used in the art such as that disclosed in WO 02/088382 to Genovoxx GmbH. As the genomic information of an individual represents a genome that comprises DNA nucleotides, genomic information will generally comprise a representation of DNA nucleotide sequence. For DNA, the common nucleotide bases comprising the sequence are selected from adenine (A), cytosine (C), guanine (G) and thymine (T). The DNA nucleotide sequence can be represented by a string comprising the characters “A”, “C”, “G” and “T” in a format as illustrated in FIG. 2. Once the genomic information is represented by a character string, the data has a splitting algorithm 10 applied as disclosed in Carsha Company Co-pending New Zealand patent application NZ531824 entitled “Methods of Secure Storage of Genomic Information and Users thereof” which is hereby incorporated in its entirety.

By way of reference, the function of a splitting algorithm is to randomise a sequence and generate information that can later be used to unrandomise the sequence. Randomisation is done in such a way that the product of the randomisation has reduced informativeness. In one aspect, one or more datasets comprise at least part of the randomised nucleotide sequence or sequences, and one or more datasets comprise part or all of the information required to unrandomise the nucleotide sequence(s).

In another aspect, one or more datasets comprise at least part of the randomised annotation information, and one or more datasets comprise part or all of the information required to unrandomise the annotation information.

Any method or process capable of dividing a nucleotide sequence into more than one component, randomising said components in order to reduce the informativeness of the nucleotide sequence, and generating information which can be used to unrandomise said components thereby to restore the informativeness of the nucleotide sequence, can be used. Any such method or process may be used in combination and/or in an iterative or recursive manner, wherein any one or more outputs of a division and randomisation process is the input for a subsequent division and randomisation process.

The separation of the genomic information into more than one dataset may comprise the separation of nucleotide sequence information and annotation information. Importantly, it should be recognized that the annotation information may be divided and randomised by the methods and processes as applied to the splitting of the nucleotide sequence information.

Once the DNA information is randomized and split into at least two datasets, the data is stored in a machine-readable storage medium.

One or more such datasets, being the Bank Data Set 12, may be stored in a central database. Conveniently the central database is remotely accessible, for example as part of a local area network, a wide area network or by way of connection to the Internet. Access to the database and/or the datasets stored therein is controlled by customer identification and authentication procedures and processes. However, the security of the genomic information stored in a central database is not solely reliant upon authentication procedures and/or encryption methods as at least one dataset that is required to render the genomic information informative is stored separately from any such central database or databases.

In a preferred aspect, at least one dataset is stored in a central database 12 and at least one dataset is stored in a portable electronic storage device 11 (whether an optical storage device, such as, for example, a CD-ROM, or a solid state device, such as, for example, a ROM memory chip or the like). The genomic information stored on at least two separate medium and in isolation to each other, each dataset on their own will present meaningless data to a third party endeavoring to obtain the individual's genomic data. It is only on the re-combining of the dataset stored on the central database 12 with the dataset stored on the portable electronic storage device 11 that will render the genomic information stored therein informative.

The datasets stored in the central database 12 and the portable storage device 11 at this stage still have the unique sample ID coding 5 attached. The portable dataset is forwarded to the customer 13 or alternatively it can be collected by the customer 13 from the sequencing service outlet 2 using their sample ID receipt label 5 as proof of ownership. Once the customer 13 has their portable dataset in their possession, the customer 13 logs-on to the sequencing service outlet 2 web page via the Internet and appends their personal details to a registration database using the sample ID code 5 as user authentication 14. Once authenticated, the customer 13 is allocated their unique customer identification (Customer ID) code 4 which is also attached to the customer's bank data set 12 stored in the sequencing service secure central database 16. Alternatively, this process can be undertaken at the sequencing service outlet 2 when the customer 13 picks up their portable dataset. The customer activates 15 their portable storage device 11 by inserting the device into a suitable machine-readable interface such that the sequencing service outlet server 18 can download the device's 11 serial number and coss-check the serial number with the customer's identification 4 and associated customer's bank dataset 12 and on completion of the authentication, download and activation code to the portable storage device 11.

The customer receives two copies of their portable data set for back-up and/or emergency purposes were one portable dataset is activated while the second copy remains inactive until required and the activation procedure 15 is undertaken. The sequencing service outlet 2 records all transactions and on request for activation of the second portable storage device the sequencing service outlet 2 automatically deactivates the first portable storage device thereby preventing illegal use of a customer's portable storage device 11.

When the sequencing service outlet 2 receives an authenticated request from an individual to access their genomic information 17, the customer inserts their portable storage device 11 into a machine-readable computer interface device such that the dataset is downloaded into the sequencing service outlet server 18. The customer's bank dataset is uploaded from the secure central database 19 and a reconstruction algorithm residing within the server software, is applied to the at least two datasets 20. The function of the reconstruction algorithm is to use the key generated by the splitting algorithm to unrandomise the sequence into a format which is informative to an individual.

In a further aspect, an individual who has in their possession their genomic sample and/or sequenced and/or digitized genomic information may also utilise the secure storage transaction system as described in the first aspect of the present invention were the steps of sequencing and/or digitizing the individual's genomic information may not be required to provide data in a format suitable for applying the splitting algorithm.

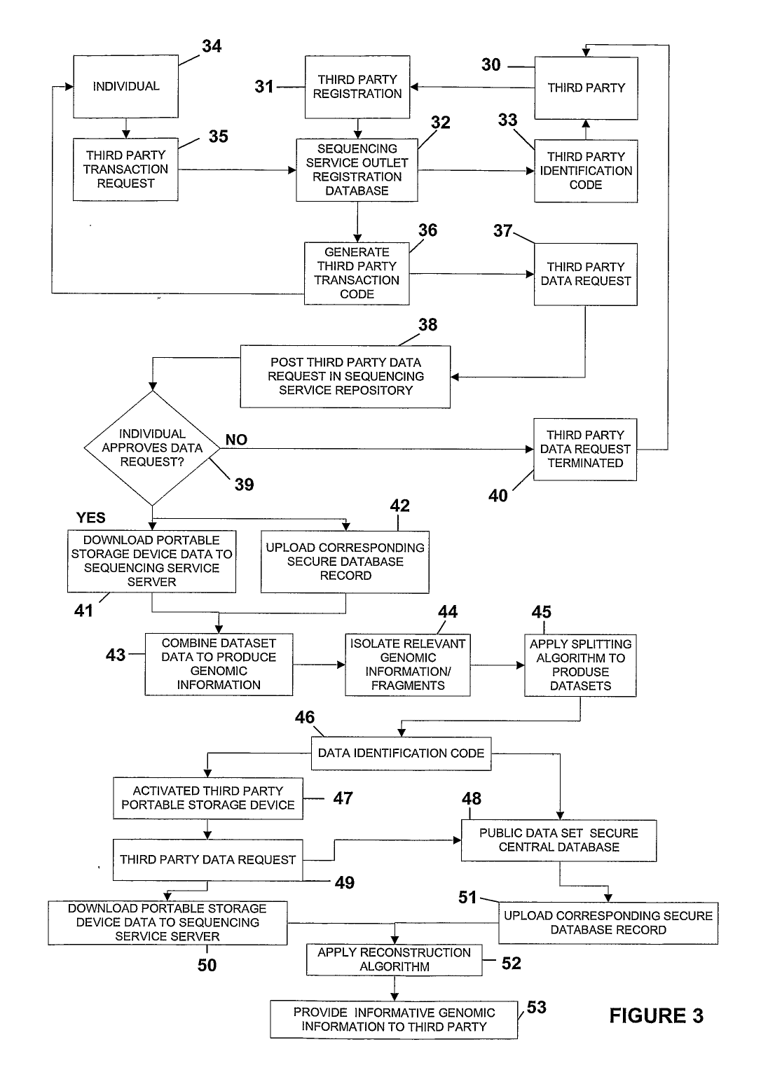

Referring now to FIG. 3, which shows an illustration of a preferred form of performing a non-anonymous transaction with the sequencing service outlet by a third party 30 such as a health care provider, medical insurance provider, diagnostic medical laboratory provider or other third party authorised to access fragments of personal genomic information. In order to gain access to the sequencing service outlet service, third parties 30 must undertake a third party registration 31 and authentication process, entering details on a registration database 32 on completion of which each third party is allocated a unique third party identification code (Third Party ID) 33.

The third party 30 requesting access to fragments or all of an individual's genomic information must obtain authorisation form the individual 34 whereby the individual 34 makes a request to the sequencing service outlet requesting third party transaction service 35 and receives a third party transaction code 36 corresponding to the service requested. The individual 34 will then disclose a third party transaction code 36 to the third party 30. The third party 30 logs-on to the sequencing service outlet server via the Internet and posts a data request 37 to the sequencing service outlet server 32. The data request comprises authentication information such as the third party transaction code 36 and third party identification code 33 plus at least the gene, genomic sequence interval, genomic information or portions thereof requested along with supplementary information including the reason for the data request. The data request is stored on the sequencing service outlet server 38 until the individual logs-on to the sequencing service outlet server 38 and downloads the data request 39. The individual can revoke third party access by rejecting the data request 39 thereby terminating the transaction process and posting a termination notice to the third party 30. Authorisation of the data request 39 is completed when the individual inputs their customer identification code.

On authorisation of the data request 39 by the individual 34, the individual 34 inserts their portable storage device into the computer interface to enable their personal dataset to be downloaded to the sequencing service outlet server 38. The sequencing service outlet server 38 then uploads the Bank Data Set from a secure central database record 42 corresponding to the customer identification code and using the reconstruction key from the portable storage device and/or Bank Data Set data, applies the reconstruction algorithm residing within the secure central database, to combine the data from the data sources to reproduce the individual's genomic information into a useable and meaningful format 43.

The genomic information may be split 44 to isolate the genomic sequence, fragment, genes requested by the third party depending on the third party data request details. The splitting algorithm 45 as previously disclosed is applied to the isolated genomic fragment, for example, to produce at least two new datasets plus a unique Data Identification code (Data ID) 46. One dataset with reconstruction key is downloaded to a third party portable storage device 47 such as CD-Rom or solid state device and becomes the Third Party Portable Data Set. The second dataset, the Third Party Bank Data Set is downloaded to a secure central database on a public data set server 48, the record being identified by the Data ID 46, under the control of the sequencing service outlet.

When the sequencing service outlet receives an authenticated request 49 from a third party to access an individual's genomic information or portions thereof, the third party inserts their third party portable dataset into a machine-readable computer interface such that the dataset is download into the sequencing service outlet server 50. The secure public dataset record is uploaded from the public dataset secure central database 51 and a reconstruction algorithm residing within the server software, is applied to the at least two datasets 52. The function of the reconstruction algorithm is to use the key generated by the splitting algorithm to unrandomise the sequence into a format which is informative to the third party 53.

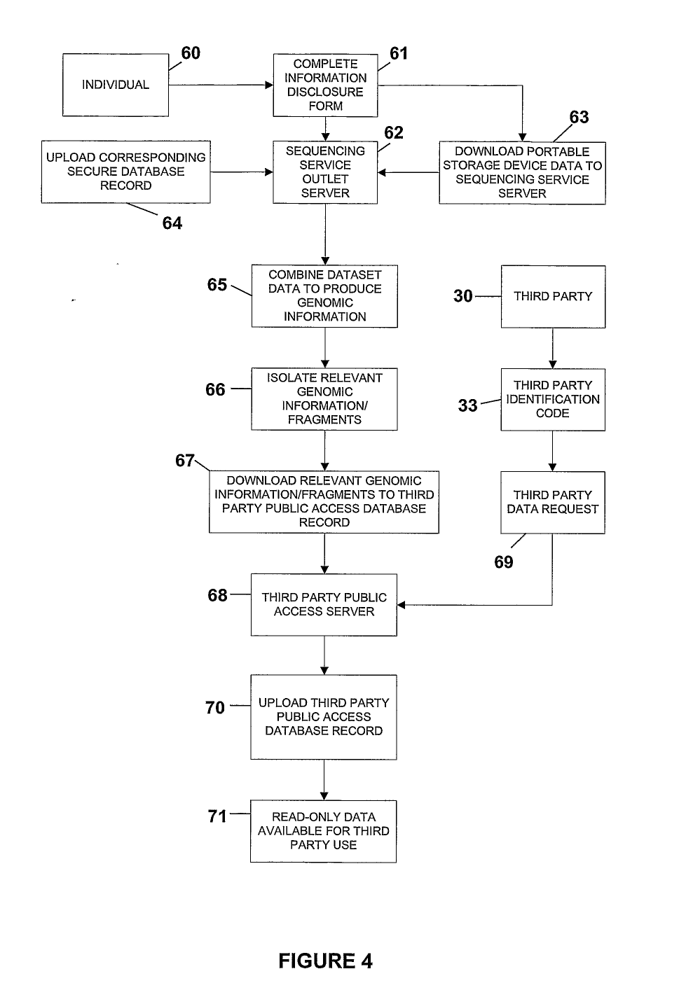

Referring now to FIG. 4, which shows an illustration of a preferred form of performing an anonymous transaction with the sequencing service outlet by a third party such as a diagnostic medical laboratory, diagnostic provider, research agency or other third party authorised to access fragments of personal genomic information. In order to gain access to the sequencing service outlet, third parties 30 must undertake a third party registration 31 and authentication process, entering details on a registration database on completion of which each third party is allocated a unique third party identification code (Third Party ID) 33 as illustrated in FIG. 3.

An individual 60 utilising the sequencing service outlet service has the option of disclosing their genomic information anonymously to third parties for the purposes, for example, of research. In order to do so, the individual 60 must complete an information disclosure form 61 either on-line via the sequencing service outlet web page or alternatively by completing the form in person at a sequencing service outlet 62. The individual enters their customer identification code and inserts their portable storage device into the computer interface to initiate the downloading of their personal dataset to the sequencing service outlet server 63. The sequencing service outlet server 63 then uploads the individual's bank data set from the secure central database 64 corresponding to the customer identification code and using the reconstruction key residing on the portable dataset and/or bank data set record, initiates the application of the reconstruction algorithm, residing within the secure central database, to combine the data from the data sources to reproduce the individual's genomic information into a useable and meaningful format 65.

The genomic information is then stored in a third party database 68 residing on a separate secure server within the sequencing service outlet service domain with no personal identification coding attached. Alternatively, the genomic information may be split to isolate specific genomic fragments relating to relevant phenotype information 66 as detailed on a sequencing service outlet survey form completed by the individual as part of the information disclosure process and the specific fragments and/or sequences downloaded to the third party access database 67 residing on the third party access server 69.

To gain access to the third party database 67 the third party 30 logs-on to the sequencing service outlet server and posts a data request 39 authenticating their request using their third party identification code 33. The authentication process thereby allows access to the genomic information residing in the third party database server 68 to be uploaded 69 in read-only form 70 thereby providing research means without the risk of relating the genomic information to a specific real-world identity.

1. A method for the secure storage of personal genomic information using a secure central database server residing within a sequencing service outlet comprising the steps of:
receiving and registering an individual's request to access and use said secure storage of personal genomic information system in a registration database and generating an interim unique identification code for said individual,
receiving and sequencing said individual's genomic sample to provide genomic information for said individual,
digitizing said genomic information,
applying a splitting algorithm to fragment and randomise said digitized genomic information and separating said fragmented and randomised information into at least two separate datasets,
storing at least one of said datasets in at least one portable storage device to be retained by said individual and storing the remainder of said datasets in a secure central database record,
activating said portable storage device by downloading an activation code from said secure central database server whereby said individual uses said interim unique identification code for authentication of their identity,
allocating to said individual a unique customer identifying code for customer identification and authentication purposes where said unique customer identifying code is also allocated to said secure central database record relating to said individual and said unique customer identification code is also allocated to said individual's personal record residing in said registration database,
receiving a request from said individual to reconstruct said individual's genomic information wherein said request includes said individual's customer identification code and log-on details,
authenticating said individual's request using said customer identification code and said log-on details and comparing the input data with said registration database,
downloading said individual's personal dataset from said individual's portable storage device using a machine-readable computer interface device, to said sequencing service outlet server,
uploading a secure central database record, identified by said individual's customer identification code and being identical to said customer identification code entered by said individual during user authentication, from said secure central database under the control of said sequencing service outlet, and
applying a reconstruction algorithm, residing within said sequencing service outlet database server to combine the data from said portable storage device with the data from said secure central database record and to provide said individual's genomic information in an informative format.

2. The method according to claim 1 wherein said secure central database record resides on a server which is accessed and controlled by a sequencing service outlet whereby said secure central database record is accessible on receipt of a data request from said individual using said unique customer identification code to authenticate their identity and downloading said individual portable storage device dataset into said server.

3. The method according to claim 1 wherein said at least two datasets include an individual's genomic information comprising nucleotide sequence information and/or annotation information generated from or relating to said individual's genetic sample plus a reconstruction key required to initiate said reconstruction algorithm residing within said sequencing service outlet secure central database server.

4. The method according to claim 1 wherein said sequencing service outlet server records account transactions for each registered individual.

5. The method according to claim 4 wherein said account transactions are downloaded into hard copy format and forwarded to said individual.

6. The method according to claim 1 wherein at least two portable storage devices are forwarded to said individual whereby one portable storage device is activated and the second portable storage device is retained by said individual in a de-activated form for back-up purposes.

7. The method according to claim 1 wherein said unique identification code is in label form for tracking said individual's genomic sample and providing an interim method by which said individual can authenticate their identity.

8. The method according to claim 1 wherein said genomic sample is taken from said individual by a pathology service provider.

9. The method according to claim 8 wherein said pathology service provider requests said unique sample identification code label from said sequencing service outlet server for attachment to said individual's genomic sample.

10. A method for the secure storage of personal genomic information with a sequencing service outlet having a secure central server comprising the steps of:
registering in a registration database an individual's request for use of said secure storage of personal genomic information,
generating two copies of a unique sample identification code in label form for tracking said individual's genomic sample and providing a interim method by which said individual can authenticate their identity,
receiving said individual's genomic information having one of said unique identification labels attached,
formatting said individual's genomic information such that said genomic information is amenable to the application of a splitting algorithm,
applying a splitting algorithm to fragment and randomise said digitized genomic information and separating said fragmented and randomised information into at least two separate datasets such that, in the absence of any one dataset, the remainder of the datasets present uninformative information,
storing at least one of said datasets in at least one portable storage device and storing the remainder of said datasets in a secure central database record,
providing said portable storage device to said individual,
receiving a log-on request from said individual,
authenticating said individual using the log-on details and said interim method of authenticating said individual's identity by comparing the input data with said registration database, and approving log-on when authentication is successful,
receiving a request for portable storage device activation when said individual uses said sample identification code for re-authentication of their identity,
activating said portable storage device by downloading an activation code to said portable storage device,
allocating to said individual a unique customer identifying code for customer identification and authentication purposes where said unique customer identifying code is also allocated to said secure central database record relating to said individual and said unique customer identification code is also allocated to said individual's personal record residing in said registration database,
receiving a request from said individual to reconstruct said individual's genomic information wherein said request includes said individual's customer identification code and log-on details,
authenticating said individual's request using said customer identification code and said log-on details and comparing the input data with said registration database,
downloading said individual's personal dataset from said individual's portable storage device using a machine-readable computer interface device, to said sequencing service outlet server,
uploading a secure central database record, identified by said individual's customer identification code and being identical to said customer identification code entered by said individual during user authentication, from said secure central database under the control of said sequencing service outlet, and
applying a reconstruction algorithm, residing within said sequencing service outlet database server to combine the data from said portable storage device with the data from said secure central database record and to provide said individual's genomic information in an informative format.

11. The method according to claim 10 wherein said registration database resides within the sequencing service outlet server.

12. The method according to claim 10 wherein said genomic information, having said unique sample identification code attached, is received from said individual.

13. The method according to claim 10 wherein said genomic information, having said unique sample identification code attached is received from a third party.

14. The method according to claim 13 wherein said genomic information, having said unique sample identification code attached is received from a third party, a DNA sequencing provider or a pathology service provider.

15. The method according to claim 10 wherein said formatting of said individual's genomic information comprises the digitization of said genomic information.

16. The method according to claim 10 wherein said formatting of said individual's genomic information comprises sequencing and the digitization of said individual's genomic information.

17. The method according to claim 10 wherein said at least two separate datasets include an individual's genomic information comprising nucleotide sequence information and/or annotation information generated from or relating to said individual's genomic sample plus a reconstruction key required to initiate said reconstruction algorithm residing within said sequencing service outlet secure central database server.

18. The method according to claim 10 wherein said sequencing service outlet records account transactions for each registered individual.

19. The method according to claim 18 wherein said account transactions are downloaded into hard copy format and forwarded to said individual.

20. The method according to claim 10 wherein at least two of said portable storage devices are forwarded to said individual where one portable storage device is activated and a second portable storage device is retained by said individual in a de-activated form for back-up purposes.

21. A method for the secure storage of personal genomic information whilst enabling non-anonymous transactions with a sequencing service outlet for third party access to all or fragments of an individual's genomic information comprising the steps of:
receiving a third party request for access to personal genomic information or fragments thereof,
logging said request in a third party registration database residing within the sequencing service outlet server,
generating a unique third party customer identification code thereby providing a method by which said third party can authenticate their identity,
receiving a log-on request from said individual,
authenticating said individual using the log-on details and a customer identification code input by said individual and comparing the input data with the registration database data, and approving log-on when authentication is successful,
receiving a third party transaction request from said individual,
recording said third party transaction request in a third party request database,
generating a unique third party transaction code for said request,
providing said third party transaction code to said individual,
receiving a third party data request from said third party which includes third party contact information, details at least the genes or genomic sequence interval and/or genomic information or portions thereof of said individual's genomic information required, to said sequencing service outlet server using said third party transaction code and said third party customer identification code for authentication of said third party,
authenticating said third party identity by comparing said third party customer identification code and said third party contact information provided in said third party data request with details residing in said third party registration database, and approving third part access on successful completion of authentication,
posting said third party data request to a data repository residing within said sequencing service outlet server for access and approval by said individual,
receiving authorisation for said third party request from said individual,
downloading said individual's personal dataset information from said individual's portable storage device using a machine-readable computer interface device, to said sequencing service outlet server,
uploading a secure central database record identified by said individual's customer identification code and being identical to said customer identification code entered by said individual during third party data request authorisation, from said secure central database under the control of said sequencing service outlet,
applying a reconstruction algorithm, residing within the sequencing service outlet database server to combine the data from said portable storage device with the data from said secure central database record to reproduce said individual's genomic information in an informative format,
isolating said genes or genomic sequence interval and/or genomic information or portions thereof of said genomic information according to said third party data request,
applying a splitting algorithm to fragment and randomise said digitized genomic information and separating said fragmented and randomised information into at least two separate datasets such that, in the absence of any one dataset, the remainder of the datasets presents uninformative information,
generating a data identification code as an access label for said datasets,
storing at least one of said datasets in a third party portable storage device and storing the remainder of said datasets in a secure public dataset database record under the control of said sequencing service outlet,
providing said third party portable storage device to said third party,
activating said third party portable storage device where said third party uses said data identification code and said third party customer identification code for authentication of their identity and an activation code is downloaded to said third party portable storage device,
receiving a request from said third party to reconstruct said individual's genomic information or portions thereof where said request includes said third party customer identification code and log-on details,
authenticating said third party request using said third party identification code, third party transaction code and said log-on details and comparing the input data with said third party registration database,
downloading said individual's personal dataset from said third party portable storage device using a machine-readable computer interface device, to said sequencing service outlet server,
uploading a secure public dataset record, identified by said third party transaction code and being identical to said third party transaction identification code entered by said third party during third party authentication, from said secure public database under the control of said sequencing service outlet, and
applying a reconstruction algorithm, residing within said sequencing service outlet database server to combine the data from said third party portable storage device with the data from said secure public database record and to provide said individual's genomic information in an informative format.

22. The method according to claim 21 wherein said third party non-anonymous transactions are available to medical laboratory, medical research, and medical diagnostic purposes and/or health care and/or medical insurance providers who register with said sequence service outlet.

23. The method according to claim 21 wherein said data request includes said third party transaction code, said third party identification code, information relating to at least details of the genes or genomic sequence interval and/or genomic information requested by said third party and business contact details of said third party.

24. The method according to claim 21 wherein said data request termination notice is posted to said third party on receipt of an unauthorised third party data request.

25. A method for the secure storage of personal genomic information whilst enabling anonymous transactions with a sequencing service outlet for third party access to whole genome sequences or fragments of an individual's genomic information comprising the steps of:
receiving, authenticating and approving if successful, a log-on request from said individual using said individual's computer log-on details and a customer identification comparing the data input with a registration database residing on a server in said sequencing service outlet,
receiving an information disclosure form request from said individual detailing at least details of the genes or genomic sequence interval and/or genomic information or portions thereof to be made available for access by an authorised third party,
downloading personal dataset information from said individual's portable storage device using a machine-readable computer interface device, to said sequencing service outlet server,
uploading of a secure central database record identified by said individual's customer identification code, from a secure central database under the control of said sequencing service outlet,
applying a reconstruction algorithm, residing within said sequencing service outlet server to combine the data from said portable storage device with the data from said secure central database record to reproduce said individual's genomic information in an informative format,
isolating and downloading said genes or genomic sequence interval and/or genomic information or portions thereof from said genomic information according to said information disclosure form request to a third party public access database record residing on a third party public access server under the control of said sequencing service outlet in a format such that said third party public access database record is anonymous having no link to a real world identity,
receiving, authenticating and approving if successful, a log-on request from a third party to provide using a third party identification code input by said third party and comparing the input data with a third party registration database record under the control of said sequencing service outlet,
receiving a third party data request detailing at least the details of the genes or genomic sequence interval and/or genomic information or portions thereof required, to said sequencing service outlet server,
uploading a third party public access database record corresponding to said third party data request, and
providing said third party public access database record to said third party.

26. The method according to claim 25 wherein said anonymous third party transactions are used for medical laboratory, medical research and/or medical diagnostic purposes.

27. The method according to claim 25 wherein said information disclosure form request includes a survey to enable third parties to collect relevant phenotype information.

28-30. (canceled)
